(19) United States
(12) Patent Application Publication
(10) Pub. No.: US 2002/0188498 A1
(43) Pub. Date: Dec. 12, 2002

(54) System and method for soliciting customer feedback

(76) Inventors: David Stoloff, Whitehouse Station, NJ (US); Rebecca Leibowitz, Summit, NJ (US)

Correspondence Address: Woodcock Washburn Kurtz, Mackiewicz & Norris LLP, One Liberty Place - 46th Floor, Philadelphia, PA, 19103, US

(21) Appl. No.: 09/879,382

(22) Filed: Jun. 11, 2001

(51) Int. Cl. G06F 17/60

(52) U.S. Cl. 705/10; 705/2

(57) ABSTRACT

A system and method for improving the design of medical products or developing new medical products by way of customer submission of unmet needs. A web site if provided that allows medical professionals that having an access to a medical products data base to submit a description of unmet needs, i.e., medical needs that are not currently addressed by available medical products. After collecting the unmet needs submissions, the unmet needs can be analyzed over a number of submissions to identify unmet needs that have been recognized by a predetermined number of medical professionals.

### TECHNICAL FIELD

The present invention relates generally to systems and methods for facilitating feedback on limitations and challenges in medical and surgical diagnostics, treatment methods and products. More particularly, the invention is directed to assist companies' focus on limitations and challenges in current diagnostic and therapeutic methods in order for them to initiate activities to improve diagnostic techniques and procedures, medical and surgical treatments, improve product designs and develop new products by providing a network-based submission mechanism for health professionals.

### BACKGROUND OF THE INVENTION

Physicians and other health professionals frequently encounter diagnostic limitations or challenges, limitations in medical and surgical treatment options (i.e. techniques, procedures, technology limitations, etc.), complications of medical or surgical treatments, and other challenges while treating patients for various diseases and conditions. (Hereinafter the term health professional refers to and may be used interchangeably with the terms physician, surgeon, clinician, nurse, medical researcher, allied health professional, and the like.) When such limitations in diagnostics, therapeutic treatment options, surgical or medical procedural or treatment complications and challenges are encountered, the medical professionals rely on training, experience, and ingenuity to overcome the complication or challenge. Often, the characterization of the medical or surgical diagnostic or therapeutic problem or issue and solution derived by the medical professional would be useful to other medical professionals or medical product companies. This information would enable medical companies to offer new and improved products and procedures that would provide the medical professional with superior diagnostic capabilities, and improved surgical treatments options for their patients.

Health professionals are often in a position to recognize a need for a product that is not commercially available, recognize the need to improve a marketed product and/or identify a problem with an existing product. The professional may be performing a diagnostic procedure or providing medical or surgical treatment and be in position to recognize improvements that are needed that could facilitate and/or improve their diagnostic capabilities, offer better medical or surgical treatment options, or increase the efficiency of the procedure while decreasing complications and improving patient outcomes. For example, a physician might notice a 20-30% recurrence rate for pelvic floor prolapse and that a more effective treatment is needed.

Currently, journals, periodicals, associations, continuing education programs, etc. provide a mechanism for the dispensation of new treatments and product needs as new complications and challenges are encountered and resolved. However, the formality and time that is often required may slow the spread of such information, particularly in the case of incremental improvements or perceived trivial changes. Moreover, recognition of the problem without a solution may deter the submission of the information by way of conventional mechanisms.

Companies desiring to provide improved products or to develop new procedures must gather such information by gleaning the information from the journals, periodical, associations and so on. Additionally, such companies may send sales personnel out to gather information from health professionals. However, such mechanisms rely on an ad hoc mechanism whereby sales personnel and other company representatives attempt to elicit information from their entire customer population of health professionals. Moreover, problems perceived by a health professional may not be recalled when the sales or marketing personnel inquire. There is no direct and time effective mechanism for health professionals to meet with the appropriate people within a health care company to discuss unmet needs and to have those needs considered. Improving communication and the collaboration between health professionals and medical companies will stimulate the advancement of health care. An improved communication pathway is needed: A mechanism for eliciting diagnostic, medical and surgical treatment needs from health professionals when the need is identified, and that provides a direct and automated mechanism for the health professional to convey this information to a company more rapidly develop and offer new and improved products and treatments to meet these needs.

### SUMMARY OF THE INVENTION

The invention contemplates a system and method for capturing unmet needs identification from a plurality of web site users. As defined herein, an unmet need is a medical or surgical diagnostic issue, medical management or treatment issue, surgical approach or treatment issue, product limitation or need that has been recognized by a user of the submission system described herein and is generally distinguished from other product problems that are specific to a particular user such as late delivery, missing parts, etc. Users connect to the unmet needs web site, for example, after reviewing product data or procedural information. Once connected to the site, a set of web pages are displayed whereby the user can submit an unmet need. The web site processes and collects the unmet need submissions for analysis and identification of significant unmet needs. In general the unmet needs are categorized by a primary topic to which the unmet needs pertain. The categorization may be done manually by way a reviewing the description of the unmet need or automatically by keyword, text analysis, etc. For example, a user could select a check box indicative of a category to identify the primary topic.

Once the unmet needs are categorized, significant unmet needs may be identified by analysis of such information as the type of specialist submitting the information, source of the submission (i.e., measuring the distribution geographically across the user base) or measuring the number of submissions related to the same primary medical topic, and so on. The identified unmet needs can then be sent to the product design teams to address the identified needs.

Additionally, a gatekeeper may be provided to filter the incoming submissions. The incoming submissions may contain product complaint information (e.g., a broken product, a delayed orders, etc.). Some of the submissions may contain information that could create legal liability to the medical products company. It may also be desirable to have a gatekeeper screen out this type of submission as well.

### BRIEF DESCRIPTION OF THE DRAWINGS

The foregoing summary, as well as the following detailed description of the preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is network diagram providing an overview of a system wherein aspects of the present invention may be incorporated;

FIG. 2 is a system level flow chart that illustrates the overall flow of information in accordance with aspects of the present invention;

FIGS. 3A and 3B are flow charts illustrating details of the flow of information in accordance with aspects of the present invention;

FIG. 4 is an example of a web page whereby a health professional may begin a problem submission;

FIG. 5 is an example of a submission terms form that informs a health professional of the terms of the submission;

FIG. 6 is an example problem submission web page in accordance with an aspect of the invention;

FIG. 7 is an example electronic message generated in accordance with an aspect of the invention; and

FIG. 8 is a bar chart showing a distribution of unmet needs.

### DETAILED DESCRIPTION OF THE INVENTION

The present invention is preferably deployed in a network environment, particularly where that network is an Internet or Intranet environment, whereby health professionals provide a company with medical need information. The term “Internet” is an abbreviation for “Internetwork,” and refers commonly to the collection of networks and gateways that utilize the TCP/IP suite of protocols, which are well-known in the art of computer networking. TCP/IP is an acronym for “Transmission Control Protocol/Internet Protocol.”The Internet can be described as a system of geographically distributed remote computer networks interconnected by computers executing networking protocols that allow users to interact and share information over the networks. Because of such wide-spread information sharing, remote networks such as the Internet have thus far generally evolved into an “open” system for which developers can design software applications for performing specialized operations or services, essentially without restriction.

Electronic information transferred between data-processing networks is usually presented in hypertext, a metaphor for presenting information in a manner in which text, images, sounds, and actions become linked together in a complex non-sequential web of associations that permit the user to “browse” or “navigate” through related topics, regardless of the presented order of the topics. These links are often established by both the author of a hypertext document and by the user, depending on the intent of the hypertext document. For example, traveling among links to the word “iron” in an article displayed within a graphical user interface in a data-processing system might lead the user to the periodic table of the chemical elements (i.e., linked by the word “iron”), or to a reference to the use of iron in weapons in Europe in the Dark Ages. The term “hypertext” was coined in the 1960s to describe documents, as presented by a computer, that express the nonlinear structure of ideas, as opposed to the linear format of books, film, and speech.

A typical networked system that utilizes hypertext conventions follows a client/server architecture. The “client” is a member of a class or group that uses the services of another class or group to which it is not related. Thus, in computing, a client is a process (i.e., roughly a set of instructions or tasks) that requests a service provided by another program. The client process utilizes the requested service without having to “know” any working details about the other program or the service itself. In a client/server architecture, particularly a networked system, a client is usually a computer that accesses shared network resources provided by another computer (i.e., a server).

Client and server communicate with one another utilizing the functionality provided by Hypertext-Transfer Protocol (HTTP). The World Wide Web (WWW) or, simply, the “Web,” includes those servers adhering to this standard (i.e., HTTP) which are accessible to clients via a computer or data-processing system network address such as a Uniform Resource Locator (URL). The network address can be referred to as a Universal Resource Locator address. For example, communication can be provided over a communications medium. In particular, the client and server may be coupled to one another via TCP/IP connections for high-capacity communication. Active within the client is a first process, known as a “browser,” which establishes the connection with the server and presents information to the user. The server itself executes corresponding server software that presents information to the client in the form of HTTP responses. The HTTP responses correspond to “web pages” constructed from a Hypertext Markup Language (HTML), or other server-generated data. Each web page can also be referred to simply as a “page.”

The client typically displays the information provided through the network by the server, using a software application known as a browser. Most browsers have modem graphical user interfaces that are capable of displaying and manipulating various types of data. A graphical user interface is a type of display format that enables a user to choose commands, start programs, and see lists of files and other options by pointing to pictorial representations (icons) and lists of menu items on the screen. Choices can be activated generally either with a keyboard or a mouse. Internet services are typically accessed by specifying a unique network address (i.e., typically with a URL). The URL address has two basic components, the protocol to be used and the object pathname. For example, the URL address, “http://www.uspto.gov” (i.e., home page for the U.S. Patent and Trademark Office), specifies a HTTP and a pathname of the server (“www.uspto.gov”). The server name is associated with one or more equivalent TCP/IP address.

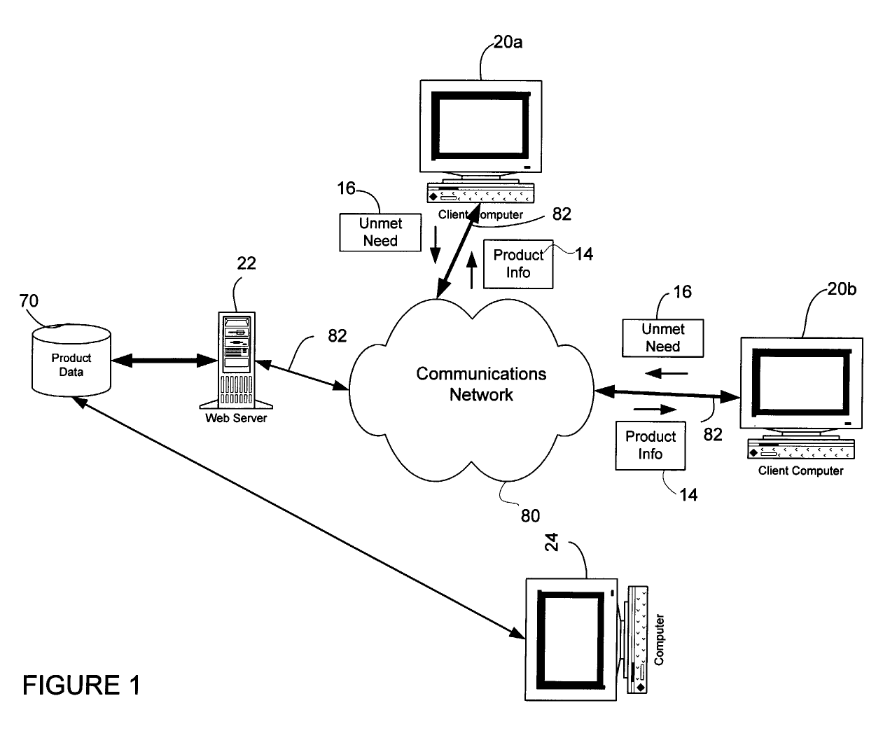

FIG. 1 illustrates an exemplary network environment in which the present invention may be employed. Of course, actual environments can be arranged in a variety of configurations; however, the environment is shown here in the context of a client-server system to provide a framework for understanding the type of environment in which the present invention operates. The system may include client computers 20a, 20b, which could be personal computers, thin clients, hand-held computing devices, and so on. Additionally, the system may include a server computer 22, and storage 70, which is coupled to and controlled by server computer 22. The client and server computers communicate with each other by way of communications network 80, which may be a LAN, a WAN, intranet, the Internet, etc.

Client computers 20a, 20b and server computer 22 are connected to communications network 80 by way of communications interfaces 82. Communications interfaces 82 can be any one of the well-known communications interfaces such as Ethernet connections, modem connections, DSL connections and so on. Communications interfaces 82 may also be by way of an intermediate communications network such as a LAN.

Users of client computers 20a, 20b may access product information 14 that is stored in data storage 70 managed by server 22. For example, the client computer 20a, 20b may be used to access medical product information stored in database 70. This product information 14 is then delivered over communications network 80 for presentation at the requesting client computer 20a, 20b. Client computers 20a, 20b may also generate feedback information in the way of unmet needs 16 that is stored in database 70. The feedback information, e.g., unmet need 16, represents unmet needs recognized by the users of client computers 20a, 20b, e.g., health professionals. The problems sought in accordance with the present invention are unmet needs, i.e. product or treatment improvements or wishes. The problem or unmet need feedback information may then be stored in database 70 and analyzed by computer 24 for product need trends. For example, if a disproportionate number of health professionals input the same need, the database 70 may be used to quickly identify the need. Thereafter, the medical product company can allocate the appropriate resources to fill the product need.

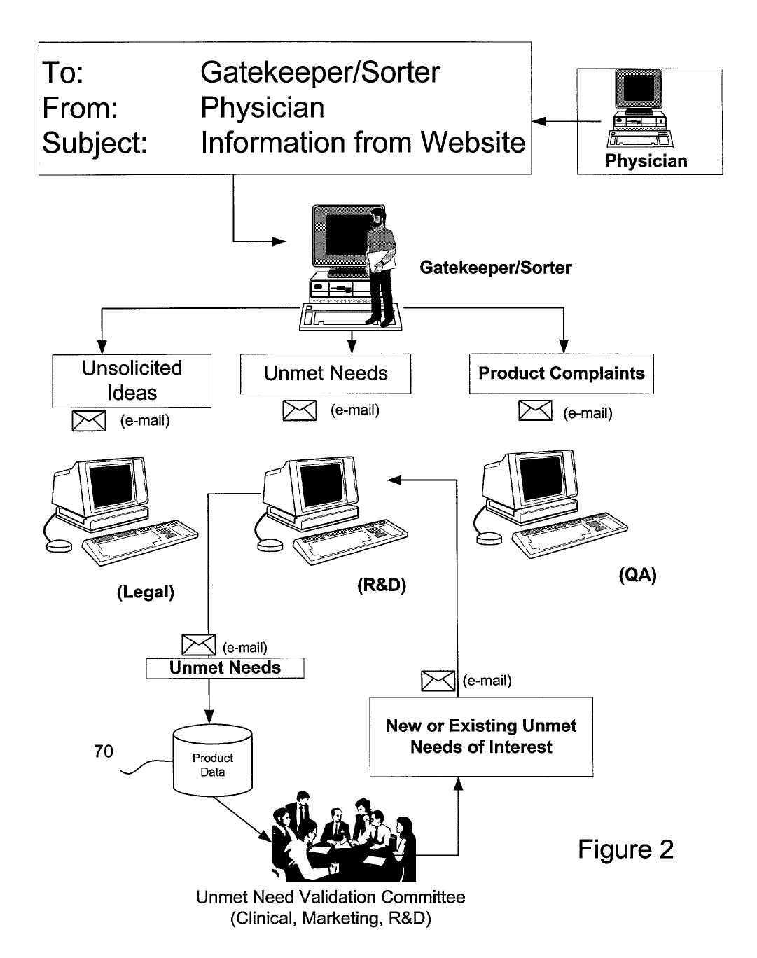

According to an aspect of the invention, FIG. 2 provides an example of a system that screens the information input by the health professionals into the network system described in FIG. 1 before storing the data in database 70. Initially, the health professional access a server computer having the medical product or treatment idea submission system by way of a network, preferably an Internetwork. As illustrated in FIG. 2, the server system 22 then steps the health professional through a submission system whereby the health professional submits the proposal for the unmet need. The submission may be through the use of a message delivery mechanism such as e-mail. The submissions are then routed by way of the server to a gatekeeper/sorter that categorizes the submission and filters out submissions for unmet needs from other submissions: i.e., unsolicited ideas may be forwarded to the legal department, product complaints are sorted to quality assurance (QA), and unmet needs are submitted to the research and development (R&D) wherein they are analyzed to identify needs of interest. The unmet needs are then transferred the database 70. A validation committee may review and analyze the data and provides feedback to R&D to address the problem.

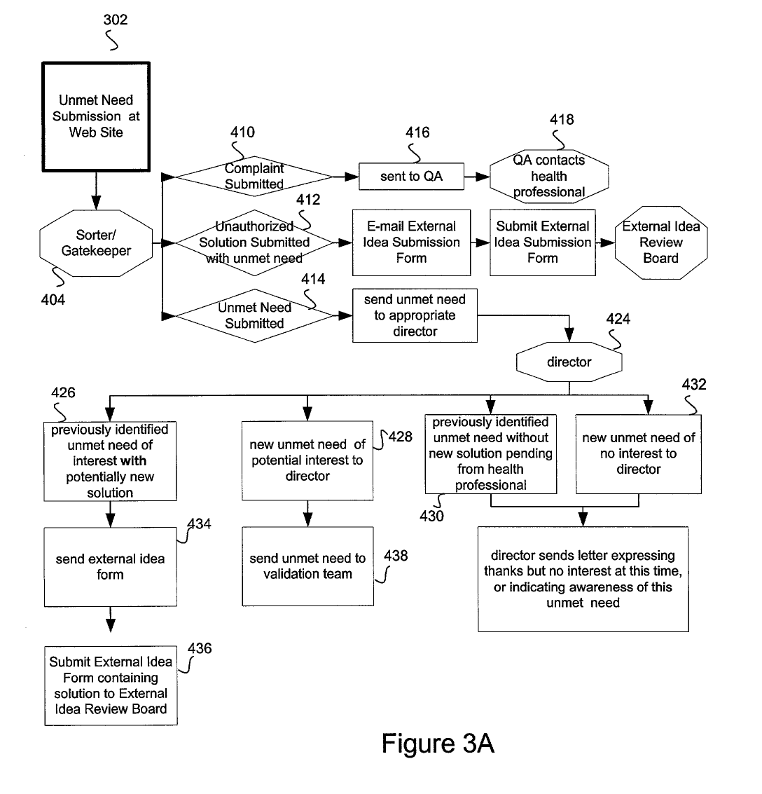

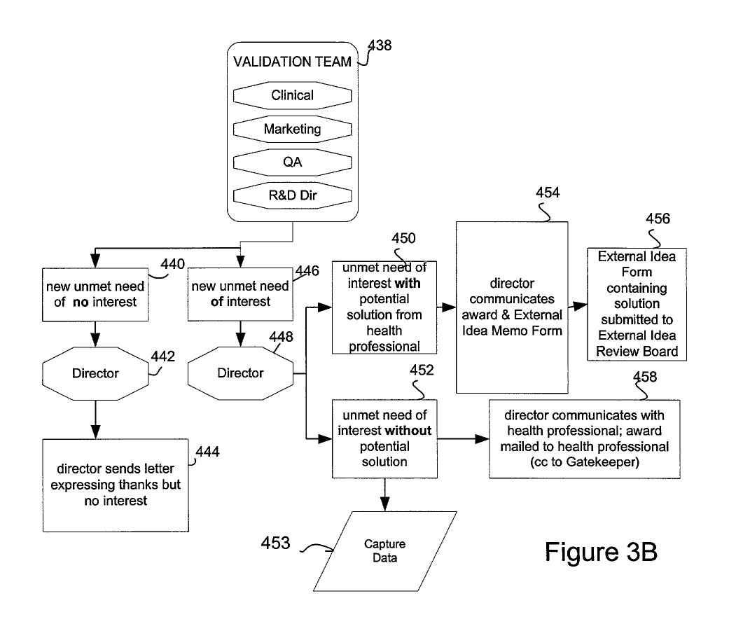

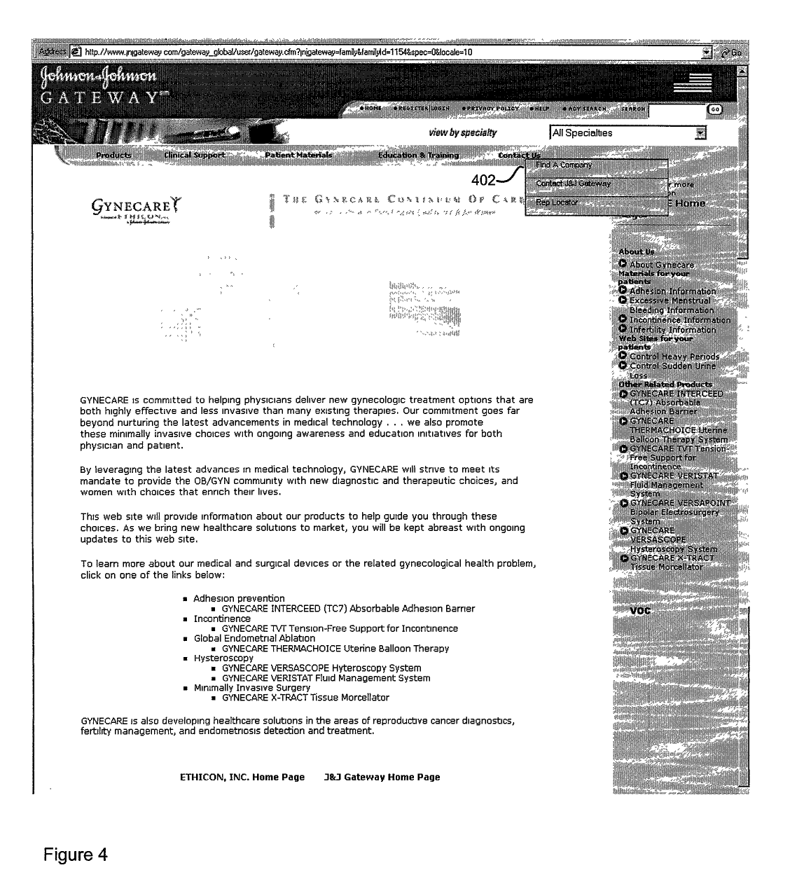

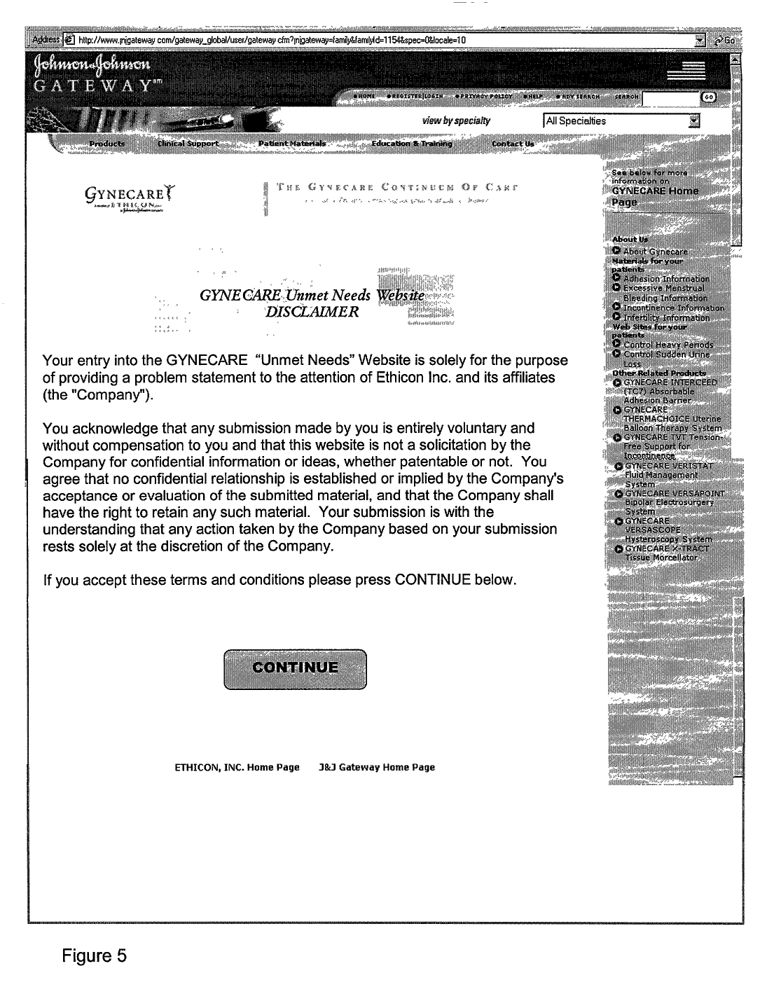

FIGS. 3A and 3B are flow charts that further detail the operation of the system described in FIG. 2. Initially, at step 302 a health professional accesses the medical products company web site and begins the submission process. FIGS. 4-7 illustrate an example web site interface for facilitating the interaction of the health professional with the web site. FIG. 4 is an initial web page that provides information to health professionals organized by specialty and areas of interest. Moreover, the web site may be designed to provide a product ordering platform for the health professional. As illustrated in FIG. 4, the health professional may select the option of contacting the medical products company by selecting option 402. Thereafter, as illustrated in FIG. 5, a disclaimer page may be displayed. This page explains that the health professional may make a submission and outlines the legal obligations of both parties. Here, the health professional is informed that the submission is voluntary, without compensation, and has not been solicited. Various other disclaimers may be fashioned depending on the particular application and desired incentives.

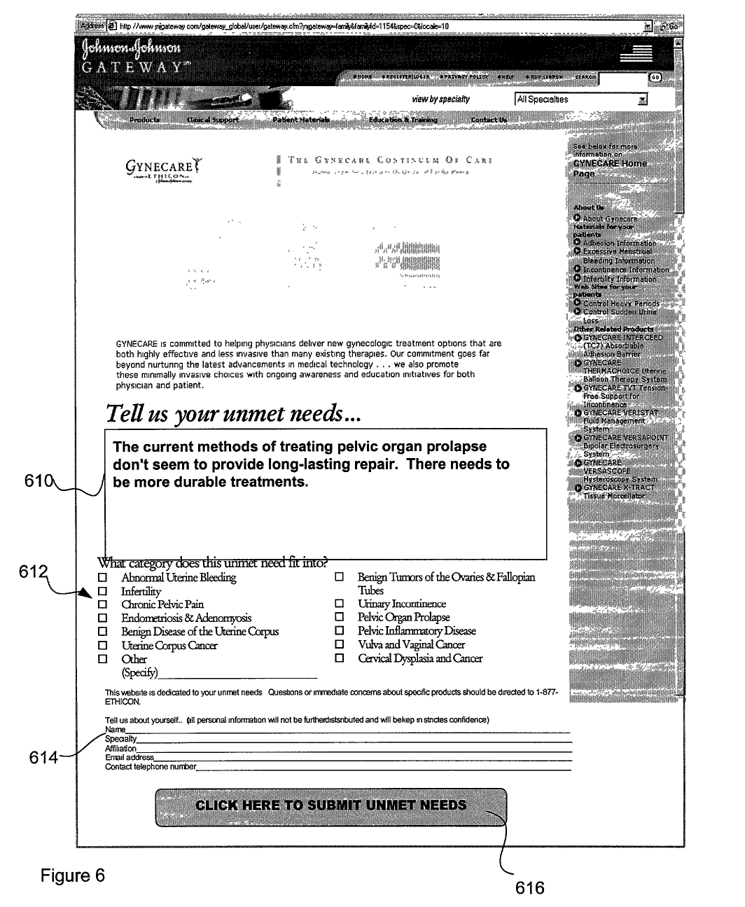

FIG. 6 illustrates an example submission page. The page contains a section for s description of the unmet need 610, which is generally free text input, a section for selecting a medical category 612, and a section for inputting user information 614, such as name of the health professional, specialty, medical institution, etc. Here, the health professional provides a description of the unmet need, selects a medical category that most closely captures the medical condition that is most directly relevant, and provides contact information such as name, address, etc. The categories 612 shown are exemplary only. Other predefined categories may be provided to further enhance the operation of the submission. For example, the medical product to which the unmet need most closely pertains may also be included to permit further automation of processing the submissions.

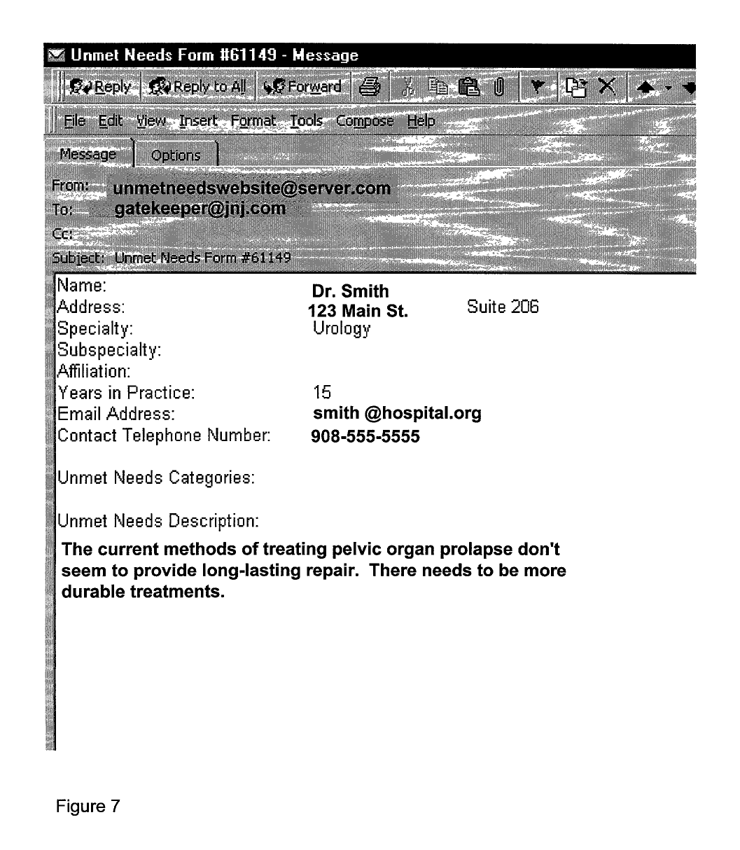

When the health professional has completed the form, he or she selects the submission option and an electronic message is generated such as the e-mail message illustrated in FIG. 7 and delivered to the appropriate recipient. Additionally, the data may be captured in data storage 70.

Referring back to FIG. 3A, the electronic message is generated and sent to a gatekeeper/sorter (step 404). Messages that are delivered to the gatekeeper/sorter are generally sorted into three categories: Complaints (step 410), unauthorized solutions (step 412), and unmet needs (step 414). The gatekeeper/sorter function could be performed by a person, by way of software using key word searches, artificial intelligence or a combination of techniques. For example, the submission form could request that the medical professional further categorize the submission. Such burdens on the health professional should be weighed against any reduction in submissions that may be caused thereby. Product complaints are sent to a quality assurance person (step 416) who then follows-up and contacts the health professional (step 418). Unauthorized solutions that are submitted are filtered out for an external idea submission. External idea submissions are then considered according to a process outside the scope of the present invention.

Unmet needs submitted in step 414 are further sorted according to category, e.g., by the category checked off on the form of FIG. 6 and delivered to the appropriate director (step 424). The director then categorizes the idea into one of four general categories: previously identified unmet need with a new solution (step 426); a newly identified unmet need of interest (step 428); a previously identified problem with no solution (step 430); or a newly identified unmet need no interest (step 432).

If the health professional has identified a new solution to a known unmet need an external idea submission form is generated and delivered to the health professional (step 434). The health professional then could submit the completed external idea submission form to an external idea review board (step 436). If the health professional has identified a new (i.e., previously unidentified) problem, the submission is forwarded to a validation team (step 438) and for processing as described with reference to FIG. 3B.

The processing of FIG. 3B is similar in some respects to the processing described in FIG. 3A. Again submissions identifying new unmet needs in which the validation team expresses no interest in pursuing are sorted out and a message sent to the health profession expressing gratitude for the submission (steps 440, 442, 444). Newly identified problems of interest to the validation team are sorted into two categories (steps 446, 448): Unmet needs that are submitted with a potential solution (step 450) and unmet needs without a solution (452). Unmet needs submitted with a solution result in an external idea submission form that is sent to the health professional (step 454) and the health professional is encouraged to submitted the idea submission to the external idea review board (step 456). Unmet needs without a solution are captured by data capture 453 and may be stored in data store 70 for later processing. A message is generated to the health professional recognizing the contribution (step 458). Unmet needs without a solution may be sent to R&D for further investigation and a possible solution.

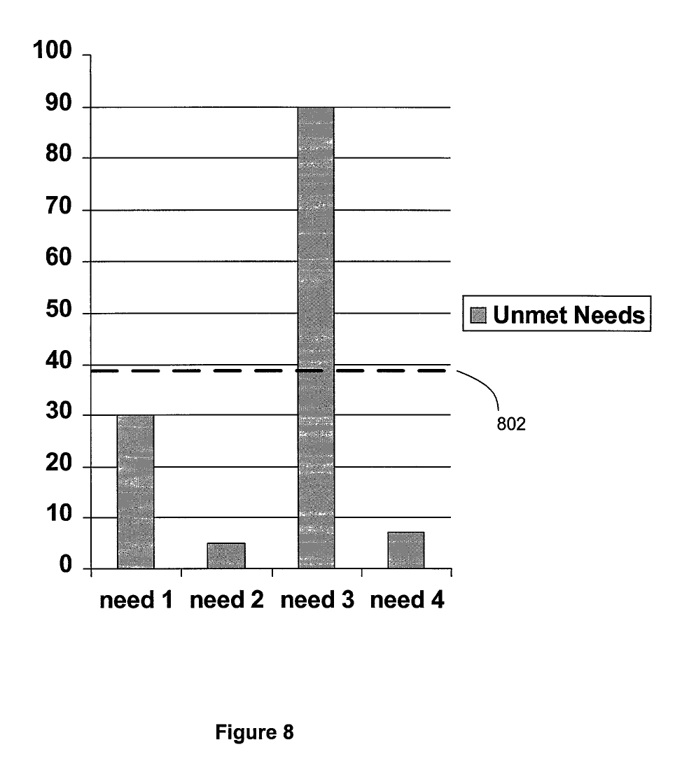

Once the submission data is captured, sorted, categorized, and so on, the data may be analyzed either manually, e.g., by a human entering or moving the data to a spreadsheet or a report, or automatically such as by periodically summarizing the data by the number of submissions in a particular category, the number of submission from a particular region, health facility, medical professional etc. FIG. 8 illustrates an example of how the submissions may be analyzed to identify unmet needs of interest. Here, a predetermined level 802 is set. Unmet need is the only unmet need that has exceeded the predetermined level. Of course, it may be that different criteria are employed to identify unmet needs of interest, such as submission from a particular health facility or health professional.

While the invention is susceptible to various modifications and alternative constructions, certain illustrated embodiments have been shown in the drawings and accompanying detailed description. It should be understood, however, that there is no intention to limit the invention to the specific constructions disclosed herein. For example, while the primary example used throughout was described in connection with gynecology, the invention is by no means limited to gynecology but could be useful in any field of medicine. As such, the invention is intended to cover all modifications, alternative constructions, and equivalents falling within the scope and spirit of the invention.

What is claimed is:

1. A computer implemented method for collecting medical product information, comprising:
providing a web site having information about medical products;
accepting on said web site input indicative of an unmet need relating to the medical products from a plurality of users;
categorizing the unmet need according to a primary topic; and
selecting those unmet needs for development where a predetermined number of unmet need submissions have the same primary topic.

2. The computer implemented method of claim 1 wherein the categorization is done performed by each said plurality of users electronically selecting a category.

3. The computer implemented method of claim 1 wherein the selecting of unmet needs having a predetermined number of unmet need submissions comprises filtering the unmet needs.

4. The computer implemented method as recited in claim 1 further comprising:
providing a gatekeeper such that the gatekeeper filters out input that relates to product complaints.

5. The computer implemented method as recited in claim 1 further comprising:
providing a gatekeeper such that the gatekeeper filters out input that describes a unmet need and a solution to the unmet need.

6. The computer implemented method as recited in claim 5 wherein an invention submission disclosure form is transmitted to the user that submitted the unmet need and the solution to the unmet need.

7. The computer implemented method as recited in claim 1 further comprising
providing a computer implemented medical products information web site in conjunction with the unmet needs input such that users can input unmet needs while obtaining medical products information.

8. A computer-readable medium bearing computer readable instructions for carrying out the steps recited in claim 1.

9. An apparatus for collecting medical product information, comprising:
a computer hosting a web site wherein the web site stores information about medical products, information about the medical products being electronically searchable and browseable;
a network connection whereby web pages are delivered to a remote computer and input is accepted from the remote computer, the network accepting an electronic submission indicative of an unmet need for the medical products whereby unmet needs related to the medical products may be determined.

10. The apparatus as recited in claim 9 further comprising a medical products purchasing database whereby a user can purchase medical products in conjunction with the submission of an unmet need submission.

11. A method of improving the operation of medical products, comprising;
retrieving a web page from a medical products server, the web page having input fields including a description field wherein an unmet need may be described, a category field whereby the medical condition to which the product need may be associated; and a submitter identification field whereby the identity of the submitter may be entered;
inputting the unmet need in the description field; and,
transmitting the web page contents to a server whereby the contents may be categorized.

12. The method as recited in claim 11 further comprising entering account information before retrieving the web page.

13. The method as recited in claim 11 further comprising retrieving a web page comprising medical product information.

14. A computer-readable medium bearing computer readable instructions for carrying out the steps recited in claim 11.

15. A system for collecting medical unmet need information, comprising:
means for providing a web site having information about medical products;
means for accepting on said web site input indicative of an unmet need relating to the medical products from a plurality of users;
means for categorizing the unmet need according to a primary topic whereby unmet needs for development may be identified where a predetermined number of unmet need submissions have the same primary topic.

16. The system as recited in claim 15 wherein the categorization is done performed by each said plurality of users electronically selecting a category.

17. The system as recited in claim 15 wherein the selecting of unmet needs having a predetermined number of unmet need submissions comprises filtering the unmet needs.

18. The system as recited in claim 15 further comprising: complaints.

19. The system as recited in claim 15 further comprising:
providing a gatekeeper such that the gatekeeper filters out input that describes a unmet need and a solution to the unmet need.

20. The system as recited in claim 19 wherein an invention submission disclosure form is transmitted to the user that submitted the unmet need and the solution to the unmet need.

21. The system as recited in claim 15 further comprising
providing a computer implemented medical products purchasing web site in conjunction with the unmet needs input such that users can input unmet needs during a medical products ordering process.
